(19) United States
(12) Patent Application Publication
(10) Pub. No.: US 2026/0086624 A1
(43) Pub. Date: Mar. 26, 2026

(54) PER-THREAD GROUP POWER LIMITER

(71) Applicant: APPLE INC, Cupertino, CA (US)

(72) Inventors: Puja GUPTA, San Jose, CA (US); Andrei DOROFEEV, Los Gatos, CA (US)

(73) Assignee: APPLE INC, Cupertino, CA (US)

(21) Appl. No.: 18/893,641

(22) Filed: Sep. 23, 2024

(51) Int. Cl. G06F 1/3296; G06F 9/30

(52) U.S. Cl. CPC G06F 1/3296; G06F 9/3009

(57) ABSTRACT

Some embodiments include a performance controller that can identify and selectively limit the power usage of one or more thread groups (TGs) corresponding to an application. Some embodiments include tracking power consumption (e.g., watts) of each TG. Examples of the power consumption can include central processing unit (CPU) power, neural engine (NE) power, dynamic random access memory (DRAM) power, and/or graphics processing unit (GPU) power. The tracked power metrics can be fed to a closed loop proportional-integral-derivate (PID) controller or limiter (e.g., a per-TG power limiter) that can converge the maximum power consumed by a given TG to a programmable threshold.

### BACKGROUND OF THE INVENTION

### Field of the Invention

The embodiments relate generally to limiting power of on a per-thread group basis.

### BRIEF SUMMARY OF THE INVENTION

Some embodiments include a system, apparatus, method, and computer program product for power management at a thread group (TG) level of an application, in contrast to system-level power management that affects many applications. Some embodiments include a performance controller that can engage TG level power limiters. Some embodiments include a computing device that can execute two or more applications each of which includes corresponding TGs. A corresponding first application TG of a first application of the two or more applications can exceed a target power threshold. The performance controller of the SoC can limit a power consumption of the corresponding first application TG, and assign the corresponding first application TG to a corresponding core type based at least on the limitation of the power consumption.

In some embodiments, to limit the power consumption of the corresponding first application TG, the performance controller can determine that a first power metric associated with the corresponding first application TG exceeds (e.g., satisfies) the target power threshold, and set the first power metric to an engaged control effort (CE) value. Further, the performance controller can determine a first CE value corresponding to a first performance metric of the corresponding first application TG, determine a minimum of the first CE value and the limited CE value, and apply the minimum to a corresponding performance map.

In some embodiments, the performance controller can determine that a second power metric of a corresponding second application TG of a second application of the two or more applications does not exceed (e.g., does not satisfy) the target power threshold. In response, the performance controller can set the first power metric to a CE value that does not limit power consumption of the corresponding second application TG. Further, the performance controller can determine a maximum dynamic voltage and frequency scaling (DVFS) state associated with the corresponding first application TG and the corresponding second application TG, and transmit the maximum DVFS state to a system-level control effort limiter.

In some embodiments, to determine the power consumption of the corresponding first application TG, the performance controller can calculate a central processing unit (CPU) power and/or a neural engine (NE) power consumed by the corresponding first application TG. Further, to the power consumption of the corresponding first application TG, the performance controller can calculate a dynamic random-access memory (DRAM) power and a graphics processing unit (GPU) power consumed by the corresponding first application TG.

### BRIEF DESCRIPTION OF THE DRAWINGS/FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system supporting per-thread group (TG) power limiters, in accordance with some embodiments of the disclosure.

FIG. 2 illustrates an example system with a system-level control effort limiter, in accordance with some embodiments of the disclosure.

FIG. 3 illustrates an example performance controller supporting per-TG power limiters, according to some embodiments of the disclosure.

FIG. 4 illustrates an example method for a performance controller supporting per-TG power limiters, according to some embodiments of the disclosure.

FIG. 5 illustrates another example method for a performance controller supporting per-TG power limiters, according to some embodiments of the disclosure.

FIG. 6 illustrates an example method for a performance controller limiting power consumption, according to some embodiments of the disclosure.

FIG. 7 is an example computer system for implementing some embodiments or portion(s) thereof.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

Some embodiments include a system, apparatus, article of manufacture, method, and/or computer program product and/or combinations and sub-combinations thereof, for managing power consumption of a thread group (TG) of an application running on a computing device. The computing device is capable of running several applications concurrently. One or more threads working towards a common goal can be called a TG. A TG can correspond to an application of one or more applications concurrently executed on the computing device. In some examples, a single application can raise the power and computation intensity of the computing device excessively, causing a system-level limiter to be engaged. When engaged, the system-level limiter can limit the power utilization of the computing device, and hence degrade performance for all of the applications, not just the single application causing the excessive power and computation usage. Some embodiments include a per-TG power limiter that can identify and selectively limit the power usage of one or more TGs corresponding to the single application.

As an example, a computing device can execute a music application and a navigation application. If one of the applications (e.g., the music application) misbehaves (e.g., due to a software error) the misbehaving application can consume an excessive amount of power creating a thermally challenging environment. Rather than causing the computing device to overheat, the demands of the music application would engage system-level limiters that would throttle power consumption of the computing device. Thus, both the music and the navigation applications may experience poor performance resulting in a negative user experience. In other words, the performance of both the music application and the navigation application would be slowed, intermittent, and/or even stopped. In addition, since system-level limiters affect the entire computing device system, other applications such as a display application could be negatively affected. Some embodiments include a per-TG power limiter that can identify and selectively limit the power usage of one or more TGs corresponding to the music application. Accordingly, only the power consumption of the music application, the misbehaving application, would be limited and the navigation application would be unaffected.

Some embodiments include tracking power consumption (e.g., watts) of each TG. Examples of the power consumption can include central processing unit (CPU) power, neural engine (NE) power, dynamic random access memory (DRAM) power, and/or graphics processing unit (GPU) power. Some embodiments include measuring power metrics as threads from a TG become active/idle. The tracked power metrics can be fed to a closed loop proportional-integral-derivate (PID) controller or limiter (e.g., a per-TG power limiter) that can manage (e.g., converge) the maximum power consumed by a given TG to a programmable threshold. The programmable threshold can be defined by a user.

Using the above example, when a per-TG power metric of the music application is operating below a set power limit (e.g., does not satisfy a target power threshold), the per-TG power limiter is not engaged. But, if the music application misbehaves where a per-TG power metric of the music application exceeds the set power limit (e.g., satisfies a target power threshold), the per-TG power limiter can be engaged. The per-TG power limiter can set the CE to an engaged CE value.

The CE of the per-TG power limiter can be used to select appropriate core type and operating frequencies. Thus, when engaged, limited CE value set by the per-TG power limiter can reduce the operating frequency and move the TG processing from a P-core to an E-core without limiting the operating frequency of TGs corresponding to other applications (e.g., the navigation application). The limited CE value and the corresponding rate of convergence can be tuned as desired. In some examples, the limited CE value and a corresponding rate of convergence can be specific to the application and/or application type.

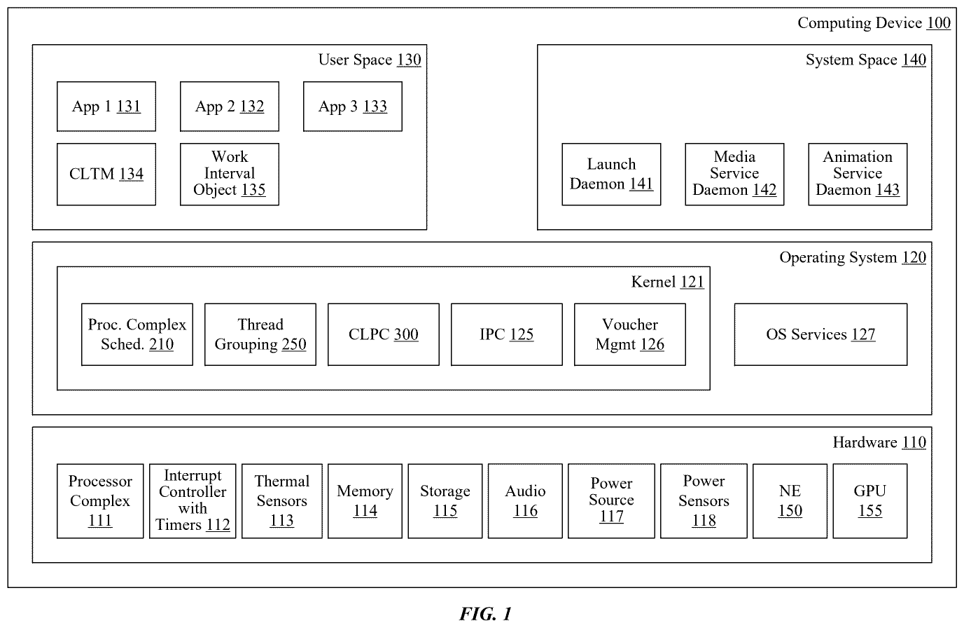

FIG. 1 illustrates an example system supporting per-TG power limiters, in accordance with some embodiments of the disclosure. The system can be a computing device 100, for example. Computing device 100 can process threads having thread groups on a processor comprising a plurality of core types, each having one or more cores, according to some embodiments. Computing device 100 can include hardware 110, operating system 120, user space 130, and system space 140.

Some examples include controlling system performance using measurements of performance metrics of groups of threads to make joint decisions on scheduling of threads and dynamic voltage and frequency scaling (DVFS) state(s) for one or more clusters of cores in a multiprocessing system having a plurality of core types and one or more cores of each core type. The performance metrics can be fed into a closed loop control system that produces an output that is used to jointly decide how fast a core is to run and on which core type the threads of a thread group are to run. A thread group comprises one or more threads that are grouped together based on one or more characteristics that are used to determine a common goal or purpose of the threads in the thread group. Some examples include minimizing thread scheduling latency for performance workloads, ensuring that performance workloads consistently find a performance core, maximizing throughput for performance workloads, and ensuring that efficiency workloads always find an efficient core. Some examples can further include ensuring that cores are not powered down when threads are enqueued for processing, and offloading performance workloads when performance cores are oversubscribed. Threads are systematically guided to cores of the correct type for the workload.

Hardware 110 can include a processor complex 111 with a plurality of core types or multiple processors of differing types. Processor complex 111 can comprise a multiprocessing system having a plurality of clusters of cores, each cluster having one or more cores of a core type, interconnected with one or more buses. Processor complex 111 can comprise a symmetric multiprocessing system (SMP) having a plurality of clusters of a same type of core, wherein at least one cluster of cores is configured differently from at least one other cluster of cores. Cluster configurations can include, e.g., different configurations of dynamic voltage and frequency scaling (DVFS) states, different cache hierarchies, or differing amounts or speeds of cache.

Processor complex 111 or a central processing unit (CPU) can additionally comprise an asymmetric multiprocessing system (AMP) having a plurality of clusters of cores wherein at least one cluster of cores has a different core type than at least one other cluster of cores. Each cluster can have one or more cores. Core types can include performance cores (P-cores), efficiency cores (E-cores), graphics cores, digital signal processing cores, and arithmetic processing cores. In an embodiment, processor complex 111 can comprise a system on a chip (SoC) that may include one or more of the hardware elements in hardware 110. In some embodiments, hardware 110 can include graphics processing unit (GPU) 155. In some embodiments, hardware 110 can include a neural engine (NE) 150, a high-performance, power/area efficient Deep Neural Network hardware accelerator.

A performance core can have an architecture that is designed for very high throughput and can support a higher operating frequency compared to an efficiency core. A performance core may consume more energy per instruction than an efficiency core. An efficient core may consume less energy per instruction than a performance core.

Hardware 110 can further include an interrupt controller 112 having interrupt timers for each core type of processor complex 111. Hardware 110 can also include one or more thermal sensors 113. In an embodiment, wherein processor complex 111 comprises an SoC, one more thermal sensors 113 can be included in the processor complex 111. In an embodiment, at least one thermal sensor 113 can be included on processor complex 111 for each core type of the processor complex 111. In an embodiment, a thermal sensor 113 can comprise a virtual thermal sensor 113. A virtual thermal sensor 113 can comprise a plurality of physical thermal sensors 113 and logic that estimates one or more temperature values at location(s) other than the location of the physical thermal sensors 113.

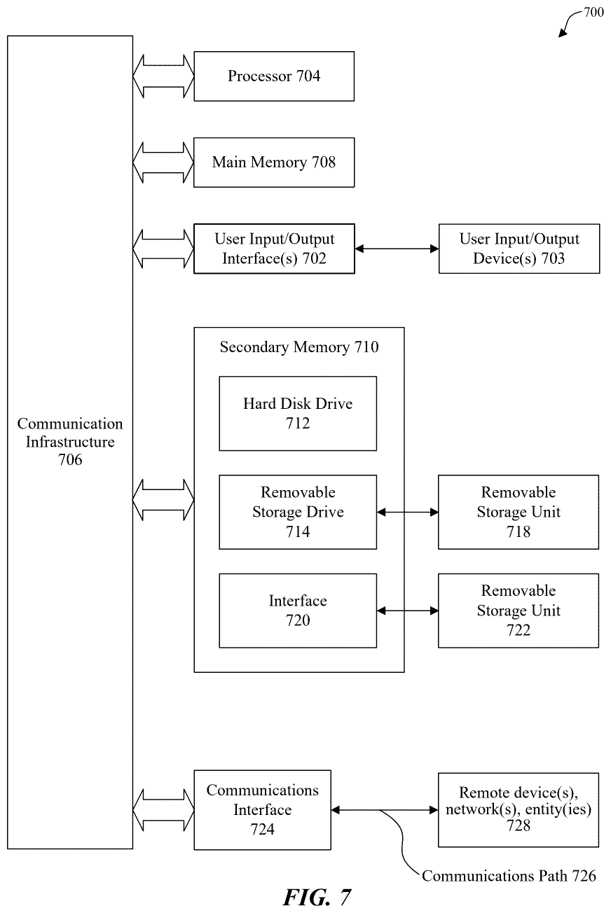

Hardware 110 can additionally include memory 114, storage 115, audio 116, one or more power sources 117, and one or more energy and/or power consumption sensors 118. Memory 114 can be any type of memory including dynamic random-access memory (DRAM), static RAM, read-only memory (ROM), flash memory, or other memory device. Storage can include hard drive(s), solid state disk(s), flash memory, USB drive(s), network attached storage, cloud storage, or other storage medium. Audio 116 can include an audio processor that may include a digital signal processor, memory, one or more analog to digital converters (ADCs), digital to analog converters (DACs), digital sampling hardware and software, one or more coder-decoder (codec) modules, and other components. Hardware can also include video processing hardware and software (not shown), such as one or more video encoders, camera, display, and the like. Power source 117 can include one or more storage cells or batteries, an AC/DC power converter, or other power supply. Power source 117 may include one or more energy or power sensors 118. Power sensors 118 may also be included in specific locations, such as power consumed by the processor complex 111, power consumed by a particular subsystem, such as a display, storage device, network interfaces, and/or radio and cellular transceivers. Computing device 100 can include the above components, and/or components as described with reference to FIG. 7, below.

Operating system 120 can include a kernel 121 and other operating system services 127. Kernel 121 can include a processor complex scheduler 210 for the processor complex 111. Processor complex scheduler 210 can include interfaces to processor complex 111 and interrupt controller 112. Kernel 121, or processor complex scheduler 210, can include thread group logic 250 that enables the closed loop performance controller (CLPC) 300 to measure, track, and control performance of threads by thread groups. CLPC 300 can include logic to receive sample metrics from processor complex scheduler 210, process the sample metrics per thread group, and determined a CE needed to meet performance targets for the threads in the thread group. CLPC 300 can recommend a core type and dynamic voltage and frequency scaling (DVFS) state for processing threads of the thread group. Inter-process communication (IPC) module 125 can facilitate communication between kernel 121, user space 130, and system space 140.

In an embodiment, IPC module 125 can receive a message from a thread that references a voucher. A voucher is a collection of attributes in a message sent via inter-process communication from a first thread, T1, to a second thread, T2. One of the attributes that thread T1 can put in the voucher is the thread group to which T1 currently belongs. IPC module 125 can pass the voucher from a first thread to a second thread. The voucher can include a reference to a thread group that the second thread is to adopt before performing work on behalf of the first thread. Voucher management 126 can manage vouchers within operating system 120, user space 130, and system space 140. Operating system (OS) services 127 can include input/output (I/O) service for such devices as memory 114, storage 115, network interface(s) (not shown), and a display (not shown) or other I/O device. OS services 127 can further audio and video processing interfaces, data/time service, and other OS services.

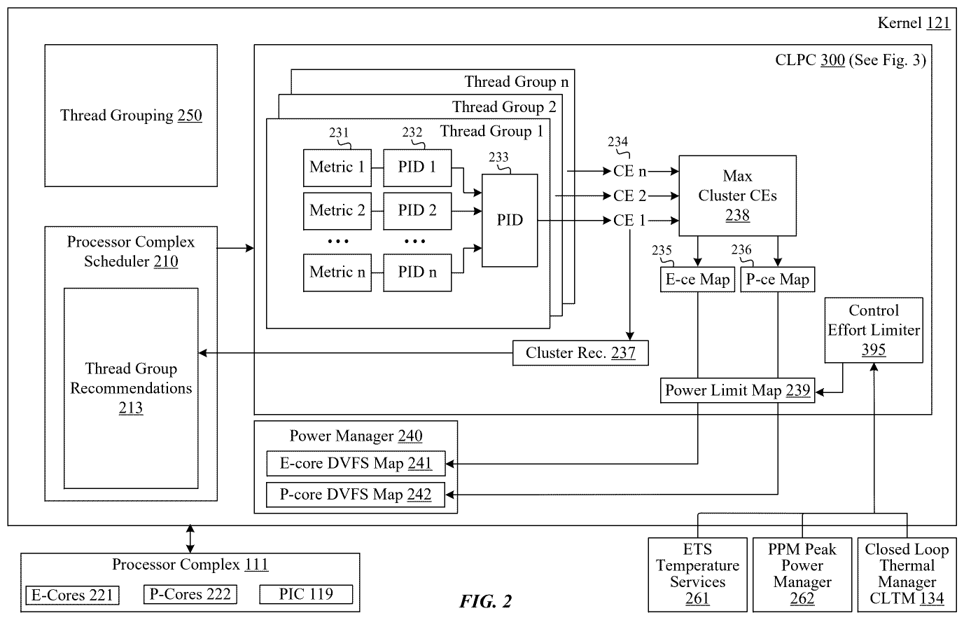

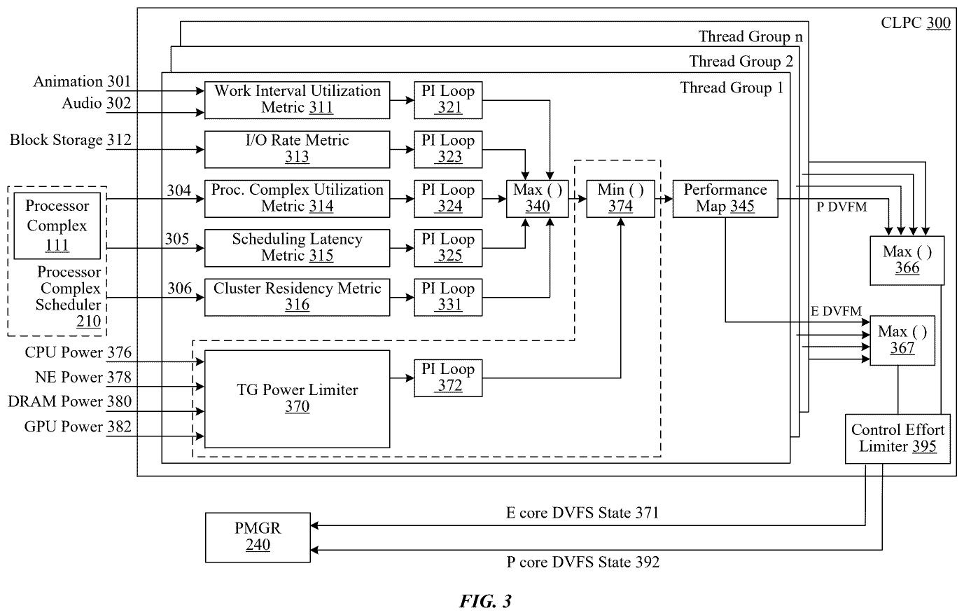

User space 130 can include one or more application programs 131-133, closed loop thermal management (CLTM) 134, and one or more work interval object(s) 135. In the above example, the music application can be App 1 131 and the navigation application can be App 2 132. CLTM 134 is described more fully, below, with reference to FIG. 2. CLTM 134 can monitor a plurality of power consumption and temperature metrics at a system-level, and feed samples of the metrics into a plurality of tunable controllers. The output of the CLTM 134 can determine a processor complex average power target used as input to a control effort limiter (CEL) 395 (shown in FIG. 3), also at a system-level, to determine a limit on a CE that is output by CLPC 300. The control effort limit can be used to limit the type of cores, number of cores of each type, and DVFS state for the cores for the processor complex 111. A work interval object 135 is used to represent periodic work where each period has a deadline. The work interval object 135 possesses a token and a specified time interval for one instance of the work. Threads that perform work of a particular type, e.g. audio compositing, and the work must be completed in a specified interval of time, e.g. a frame rate of audio, can be associated with the work interval object 135. User space 130 can include a plurality of work interval objects 135. A work interval object 135 can have its own thread group, as may be specified in source code, compiled code, or a bundle of executables for execution. Threads that perform work on behalf of the work interval object 135 can opt-in to the thread group of the work interval object 135. For threads that have opted-in and adopted the thread group of the work interval object 135, work performed by the threads, on behalf of the work interval object 135, is associated with the thread group of the work interval object 135 for purposes of CLPC 300 operation.

System space 140 can include a launch daemon 141 and other daemons, e.g. media service daemon 142 and animation daemon 143. In an embodiment, threads that are launched by a daemon that perform a particular type of work, e.g. daemons 142 and 143, can adopt the thread group of the daemon. Execution metrics of a thread that adopted the thread group of the daemon that launched the thread are attributable to the thread group of the daemon for purposes of CLPC 300 operation.

FIG. 2 illustrates an example system 200 with a system-level control effort limiter, in accordance with some embodiments of the disclosure. As a convenience and not a limitation, FIG. 2 may be described with reference to elements from other figures in the disclosure. For example, FIG. 2 can describe, at a high level, interactions between subsystems described above, with reference to FIG. 1. System 200 can process threads having thread groups on processor complex 111 including a plurality of core types each having one or more cores, according to some embodiments. A thread group comprises one or more threads that are grouped together based on one or more characteristics that are used to determine a common goal or purpose of the threads in the thread group. FIG. 2 describes, at a high level, the interaction between subsystems described above, with reference to FIG. 1.

System 200 can include a kernel 121 that is part of an operating system, such as operating system 120 of FIG. 1. Kernel 121 can include processor complex scheduler 210, thread grouping logic 250, closed loop performance control (CLPC) 300, and power manager 240. A processor or CPU, such as processor complex 111 of FIG. 1, can interface to kernel 121 and subsystems of kernel 121. A closed loop thermal manager (CLTM) 134 can interface with CLPC 300 to provide a processor complex average power target temperature at the system-level rather than on a per-TG basis that is used by CLPC 300 to modify or limit recommended processor core types and/or dynamic voltage and frequency scaling (DVFS) states for one or more processor core types. In an embodiment, CLTM 134 can execute in user process space 130 or system space 140, as shown in FIG. 1.

Processor complex 111 can comprise a plurality of processor core types of an asymmetric multiprocessing system (AMP) or a symmetric multiprocessing system (SMP). In an AMP, a plurality of core types can include performance cores (P-cores) and efficiency cores (E-cores). In an SMP, a plurality of cores types can include a plurality of cores configured in a plurality of different configurations. Processor complex 111 can further include a programmable interrupt controller (PIC) 119 that can have one or more programmable timers that can generate an interrupt to a core at a programmable delay time. In an embodiment, PIC 119 can have a programmable timer for the processor complex 111. In an embodiment, PIC 119 can have a programmable timer for each core type in the processor complex 111. For example, PIC 119 can have a programmable timer for all P-cores 222 and another programmable timer for all E-cores 221. In an embodiment, PIC 119 can have a programmable timer for each core of each core type.

Processor complex scheduler 210 can manage thread queues, thread group performance data, and a plurality of thread queues for each of a plurality of processor core types. In an example processor complex 111, processor complex scheduler 210 can have an E-core thread queue 215 and a P-core thread queue 220. Processor complex scheduler 210 can manage the scheduling of threads for each of the plurality of cores types of processor complex 111. Functions can further include logic to a program interrupt controller for immediate and/or deferred interrupts. Processor complex scheduler 210 can collect thread execution metrics for each of a plurality of thread groups executing on processor complex 111. A plurality of thread execution metrics 231 can be sampled from the collected thread execution metrics of processor complex scheduler 210 and provided to a plurality of tunable controllers 232 of CLPC 300 for each thread group. Tunable controllers 232 can be proportional-integral-derivate (PID) controllers or a proportional-integral (PI) loop controller.

A PID controller has an output expressed as:

$$u ( t ) = {K}_{p} e ( t ) + {K}_{i} {\int }_{0}^{t} e ( τ ) d τ + {K}_{d} \frac{de ( t )}{d ( t )} ,$$

where Kₚ is the proportional gain tuning parameter, Kᵢ is the integral gain tuning parameter, K_{d} is the derivative gain tuning parameter, e(t) is the error between a set point and a process variable, t is the time or instantaneous time (the present), and τ is the variable of integration which takes on values from time 0 to the present time t.

Thread group recommendation manager 213 of processor complex scheduler 210 can receive core type (cluster) recommendations from CLPC cluster recommendations 237 for each thread group that has been active on processor complex 111. Processor complex scheduler 210 can utilize the cluster recommendations 237 for each thread group to program threads of each thread group onto an appropriate core type queue, (e.g., E-core thread queue or a P-Core thread queue).

CLPC 300 is a closed loop performance controller that determines, for each thread group active on a core, a CE needed to ensure that threads of the thread group meet their performance goals. A performance goal can include ensuring a minimum scheduling latency, ensuring a block I/O completion rate, ensuring an instruction completion rate, maximizing processor complex utilization (minimizing core idles and restarts), and ensuring that threads associated with work interval objects complete their work in a predetermined period of time associated with the work interval object. Metrics can be periodically computed by CLPC 300 from inputs sampled by CLPC 300 either periodically or through asynchronous events from other parts of the system.

In an embodiment, inputs can be sampled at an asynchronous event, such as the completion of a work interval object time period, or a storage event. A plurality of performance metrics 231 can be computed within CLPC 300 and each fed to a tunable controller 232. Tunable controllers 232 generate an output to a tunable thread group PID 233, which in turn outputs a CE 234 needed for the thread group to meet its performance goals.

In an embodiment, a CE 234 is a unitless value in the range 0 . . . 1 that can be mapped to a performance map and used to determine a cluster recommendation 237 for the thread group. The cluster recommendations 237 are returned to thread group manager 213 in processor complex scheduler 210 for scheduling threads to core types. For each IO of thread groups 1 . . . n, a CE 234 (e.g., CE 1 . . . n) collected by a cluster maximum control effort module 238. Cluster maximum control effort module 238 determines a maximum CE value for all control efforts CE 1 . . . n 234 for each cluster type. Maximum control effort module 238 outputs maximum CE for each cluster type to a respective cluster type mapping function, e.g., E-ce map 235 and P-ce map 236. E-ce map 235 determines a dynamic voltage and frequency scaling (DVFS) state for E-cores based upon the maximum E-cluster CE output from maximum control effort module 238. Similarly, P-ce map 236 determines a DVFS state for P-cores based upon the maximum P-cluster CE output from maximum control effort module 238. These respective maximum DVFS states may be limited by an output of CEL 395 of CLPC 300. For example, the respective maximum DVFS states can be limited by an output of CEL 395 of CLPC 300. CEL 395 is described further, below, with reference to FIG. 3. Power limit map 239 receives the maximum P-cluster and E-cluster DVFS states, and receives the control effort limit from CEL 395, and maps a control effort limit from CEL 395 to a DVFS state for each core type. CEL 395 may also limit a number of each type of core that can execute by masking off certain cores. Power limit map 239 outputs the DVFS state for each core type to power manager 240 to set the DVFS state, and number of active cores in an E-core DVFS map 241 and P-core DVFS map 242. CEL 395 can receive input from a plurality of temperature control loops 261, a peak power manager 262, and a closed loop thermal manager (CLTM) 134.

The previous example of running two or more applications (e.g., a music application and a navigation application) on a computing device is further described with elements of FIG. 2 with a system-level control effort limiter (e.g., CEL 395). When thread group 1 corresponding to the music application demands excessive computing resources, performance metrics 231 and TG controllers 232 increase performance. Initially, TG controllers 232 start by setting a low CE resulting in minimum performance at the beginning. In other words, the music application thread groups run on E-core at a minimum frequency (fmin). As the music application threads of thread group 1 are running at a high rate (e.g., 70-100% of the time) on CPU cores, CLPC 300 increases the performance for the music application thread group by raising CPU performance states that take the E-core frequency to a maximum frequency (fmax). As the music application threads continue running, CLPC 300 would then move music application thread groups to run on P-core at fmin, and eventually to P-core fmax. P-cores utilize significant power, and running at higher performance states causes the computing device to heat up and engage system-level throttlers. For example, temperature services or temperature control loops 261, peak power manager 262, and/or closed loop thermal manager (CLTM) 134 could transmit signals to CEL 395 to initiate system-level power limits. The system-level power limits can cause reduced performance for the music application and other applications. For example, the navigation application and other functions of the computing device (e.g., a display) could have reduced power and hence reduced performance as well. This results in an overall poor user experience with the computing device. Some embodiments include an example performance controller (e.g., CLPC 300) supporting per-TG power limiters to address the problem of system-level limitations that affect performance of applications running on a computing device even though those applications (e.g., navigation application, display application) are not the cause of excessive power consumption.

FIG. 3 illustrates an example performance controller, CLPC 300, supporting per-TG power limiters, according to some embodiments of the disclosure. As a convenience and not a limitation, FIG. 3 may be described with reference to elements from other figures in the disclosure. For example, FIG. 3 can describe interactions between subsystems described above, with reference to FIG. 1 and FIG. 2. CLPC 300 includes components for processing threads having thread groups on processor complex 111 comprising a plurality of core types each having one or more cores, according to some embodiments. For each of a plurality of thread groups (e.g., Thread Group 1, 2, . . . n) that have been active on a core, CLPC 300 can receive a sample of each of a plurality of performance metrics. An ‘input’ into CLPC 300 denotes information obtained by CLPC 300 either by periodically sampling the state of the system or through asynchronous events from other parts of the system. A ‘metric’ is computed within CLPC 300 using one or more inputs and could be fed as an input to its tunable controller and controlled using a tunable target. A metric is designed to capture a performance trait of a workload. Input sources can include, e.g., animation work interval object (WIO) 301, audio WIO 302, block storage I/O 312, and processor complex 111.

Many workloads are targeted towards a user-visible deadline, such as video/audio frame rate, for example. The processor complex 111 performance provided for such workloads needs to be sufficient to meet the target deadlines, without providing excess performance beyond meeting the respective deadlines, which is energy inefficient. Towards this end, for each video/audio frame (work interval), CLPC 300 receives timestamps from audio/rendering frameworks about when the processor complex 111 started working on the frame (start), when the processor complex 111 stopped working on the frame (finish) and what is the presentation deadline for the frame (deadline). CLPC 300 computes work interval utilization metric 311 for the frame as (finish-start)/(deadline-start). The work interval utilization is a measure of the proximity to the deadline. A value of 1.0 would indicate ‘just’ hitting the deadline. However, since the processor complex 111 is not the only agent in most workloads and dynamic voltage and frequency scaling (DVFS) operating points are discrete, and not continuous, a goal is to provide enough performance to meet the deadline with some headroom, but not so much headroom as to be energy inefficient.

Work interval-based control is reactive in nature. Hence, it is susceptible to offering a poor transient response when there is a sudden increase in the offered processor complex 111 load (for example, a frame that is inordinately more complex than the last ‘n’ frames). To achieve a degree of proactive response from the CLPC 300, video/audio APIs (e.g., Animation WIO 301 and/or Audio WIO 302) allow higher level frameworks to interact with CLPC 300 as soon as a new frame starts being processed and convey semantic information about the new frame such as its complexity. Work interval utilization metric 311 is fed to tunable controller (e.g. proportional integral controller loop (PI Loop) 321 having a target T_{PT}. A difference between T_{PT} and the work interval utilization metric 311 is determined and multiplied by a tuning constant, Kᵢ, for the tunable controller, PI Loop 321. In some examples, a PID controller can replace a PI Loop.

An input/output (I/O) bound workload, such as block storage I/O 312 (e.g., corresponding to storage 115), interacts heavily with non-processor complex subsystems such as storage or a network. Such workloads typically exhibit low processor complex utilization and might appear uninteresting from a processor complex performance standpoint. However, the critical path of the workload includes some time spent on the processor complex 111 for managing meta-data or data going to or from the non-processor complex subsystem. This is typically time spent within kernel drivers such as a Block Storage Driver (for storage) and Networking Drivers (e.g. for Wi-Fi/mobile data transfers). Hence processor complex 111 performance can become a bottleneck for the I/O. The I/O rate metric computes the number of I/O transactions measured over a sampling period and extrapolates it over a time period, e.g., one second. I/O rate metric 313 is fed to tunable controller 323 having a target T_{I/O}. A difference between T_{I/O} and the I/O rate metric 313 is determined and multiplied by a tuning constant, Kᵢ, for the tunable controller 323.

Processor complex scheduler 210 can accumulate statistics that measure processor complex utilization 304, scheduling latency 305, and cluster residency 306. Processor complex utilization 304 can measure an amount, such as a percentage, of utilization of the processor complex cores that are utilized over a window of time. The measured or computed value for processor complex utilization 304 can be sampled and be fed as a metric to processor complex utilization metric 314. A purpose of the processor complex utilization metric 314 is to characterize the ability of a workload to exhaust the serial cycle capacity of the system at a given performance level, where the serial cycle capacity examines the utilization of the processor complex as a whole. For each thread group, CLPC 300 can periodically compute the processor complex utilization metric 314 as (time spent on core by at least a single thread of the group)/(sampling period). The processor complex utilization metric 314 can be defined as a “running utilization”, e.g., it only captures the time spent on-core by threads. Processor complex utilization metric 314 can be sampled or computed from metrics provided by the processor complex scheduler 210. The processor complex scheduler 210 can determine a portion of time during a sample period that thread(s) from a thread group were using a core of the processor complex 111. Processor complex utilization metric 314 is fed to tunable controller 324 having a target T_{UTILIZATION}. A difference between T_{UTILIZATION} and the processor complex utilization metric 314 is determined and multiplied by a tuning constant, Kᵢ, for the tunable controller 324.

In an embodiment, the “runnable utilization” of a thread group can be measured, which is computed through the time spent in a runnable state (running or waiting to run) by any thread of the group. This has the advantage of capturing thread contention for limited processor complex cores; a thread group that spends time waiting for processor complex 111 access will exhibit higher runnable utilization. Considering thread contention takes into account the period in which a thread is able to be run, relative to the amount of time in which the thread is running. When a large number of threads are contending for access to processor cores, threads will spend a larger amount of time in a runnable state before going on-core. Performing closed loop control around the processor complex utilization metric 314 for a thread group will give higher execution throughput to this thread group once it eventually goes on-core, the idea being to try and pull in the completion time of the threads of the thread group to better approximate what they would have been in an un-contended system.

Scheduling latency 305 can measure an amount of latency that threads in a thread group experience between a time that a thread of a thread group is scheduled and the time that the thread is run on a core of the processor complex 111. Scheduling latency 305 can be sampled for a window of time for a thread group and provided to CLPC 300 as a scheduling latency metric 315. In some embodiments, thread scheduling latency metric 315 serves as a proxy for the runnable utilization of a thread group if runnable utilization cannot be directly determined from the processor complex 111. Scheduling latency metric 315 can be provided by the processor complex scheduler, e.g. processor complex scheduler 210 of FIG. 2. The processor complex scheduler 210 can determine when a thread of a thread group went on core, then off core. For all threads in the thread group, processor complex scheduler 210 can determine how much time the thread group spent running on cores. For each sampling period, CLPC 300 can measure the maximum scheduling latency experienced by threads of a thread group. This input can be filtered using an exponentially-weighted moving average filter since CLPC 300 samples the system at a faster rate than the scheduling quantum. Performing closed loop control around the thread scheduling latency metric 315 gives CLPC 300 the flexibility of providing a different response for potential on-core activity compared to actual on-core activity. Thread scheduling latency metric 315 is fed to tunable controller 325 having a target T_{LATENCY}. A difference between T_{LATENCY} and the scheduling latency metric 315 is determined and multiplied by a tuning constant, Kᵢ, for the tunable controller 325.

Cluster residency 306 can measure an amount of time that threads of a thread group are resident on a cluster of cores, such as E-cores or P-cores. Cluster residency 306 can be sampled for a window of time for a thread group and provided as a metric to cluster residency metric 316. In an embodiment, cluster residency metric 316 can have a sample metric for each of one or more cluster of core types, such as E-cores and P-cores. In an embodiment, cluster residency metric 316 comprises E-cluster residency metric and a P-cluster residency metric, and RS Occupancy Rate metric. E-cluster residency metric is a measure of an amount of time that a thread group executes on a cluster of efficiency cores. P-cluster residency metric 318 is a measure of an amount of time that a thread group executes on a cluster of performance cores. RS Occupancy Rate metric is a measure of reservation station occupancy, which is a measure of how long a workload waits in a ready state before being dispatched to a processor pipeline. CE for cluster residency for a thread group can be determined from cluster residency metric 316, including E-cluster residency metric and P-cluster residency metric, and RS Occupancy rate, by feeding the cluster residency metric 316 to controller 331.

Each of the above metrics 311, 313-315, and 316 can be fed to a corresponding tunable controller, e.g. 321, 323-325, and 331 that outputs a contribution to a CE for threads of the thread group. Each tunable controller, e.g. 321, 323-325, and 331 can have a target value, e.g., T_{PT} for the corresponding performance metric, and a tuning constant Kᵢ.

An integrator (e.g., maximum function 340) can sum the contributions of the outputs from PI loops 321, 323-325, and 331 to generate a unitless CE for the thread group in the range of 0 . . . 1. A CE of 0 can imply a TG running at a minimum frequency (e.g., utilizing an efficient type core (E-core)) and a CE of 1 can imply a TG running at a maximum frequency (e.g., utilizing a performance type core (P-core)).

Some embodiments include measuring power metrics for a thread group as threads from a thread group become active/idle. Some examples include using hardware counters to measure the power metrics for a thread group as a thread group becomes active and/or idle. Some embodiments include using a closed loop PID limiter (e.g., thread group (TG) power limiter 370) with the tracked power metrics to converge the maximum power consumed (e.g., power metrics) by a given thread group to a programmable threshold (e.g., a engated CE value) that can be defined by a user. TG power limiter 370 can be a per-TG power limiter.

Examples of power metrics measured can include: CPU power 376; neural engine (NE) power 378 (e.g., power usage corresponding to a TG processed with NE 150); DRAM power 380 (e.g., power usage corresponding to a TG accessing memory 114); and/or GPU power 382 (e.g., power usage corresponding to a TG utilizing GPU 155). For example, CPU power 376 includes power usage corresponding to a TG (e.g., Thread Group 1) processed on a CPU of processor complex 111. TG power limiter 370 can measure the CPU energy/power consumed by threads of a TG when they run on processor complex 111 and can reduce the performance of cores if a power metric exceeds a target power threshold. In contrast, processor complex utilization metric 314 can measure absolute time metrics of threads from a TG running on a core (e.g., processor complex utilization 304), and can increase the performance of cores if an absolute time metric exceeds a threshold. In some embodiments, TG power limiter 370 can measure DRAM power 380 consumed by threads of a TG accessing memory 114, and can reduce performance if a power metric exceeds a target power threshold. In contrast, block storage 312 includes I/O rate measurements accessing memory 114 and can increase performance of cores accordingly.

CLPC 300 can accumulate statistics that measure the power metrics on a per-TG basis from hardware counters on hardware 110: CPU power 376, NE power 378, DRAM power 380, and/or GPU power 382. In some embodiments, CLPC 300 can access one or more of the power metric measurements via processor complex scheduler 210. CPU power 376 can be a per TG measurement of the amount of power utilization of the processor complex cores. For example, hardware counters can be utilized to measure a power (e.g., energy) value of a TG (e.g., Thread group 1) running on one of the CPU cores of processor complex 111. The energy value on the hardware counters can be first read when the TG comes on the CPU core and read a second time when the TG goes off the CPU core. The difference between the first read energy values and the second read energy values can indicate the energy consumed during the time the TG was running on the CPU core(s) of processor complex 111.

NE power 378 can be a per TG measurement of the amount of power utilization corresponding to NE 150. For example, CLPC 300 can access hardware counters utilized to measure the energy value of Thread group 1 utilizing NE 150. The energy value on the hardware counters can be first read when the TG begins to utilize NE 150 and read a second time when the TG stops utilizing NE 150. The difference between the first read energy values and the second read energy values can indicate the energy consumed during the time the TG was utilizing NE 150.

DRAM power 380 can be a per TG measurement of the amount of power utilization corresponding to accessing memory 114 (e.g., DRAM). For example, CLPC 300 can access hardware counters utilized to measure the energy value of a Thread group 1 accessing memory 114. The energy value on the hardware counters can be first read when the TG begins to access memory 114 and read a second time when the TG stops accessing memory 114. The difference between the first read energy values and the second read energy values can indicate the energy consumed during the time the TG was accessing memory 114.

GPU power 382 can be a per TG measurement of the amount of power utilization corresponding to utilizing GPU 155. For example, CLPC 300 can access hardware counters utilized to measure the energy value of a Thread group 1 utilizing GPU 155. The energy value on the hardware counters can be first read when the TG begins to utilize GPU 155 and read a second time when the TG stops utilizing GPU 155. The difference between the first read energy values and the second read energy values can indicate the energy consumed during the time the TG was utilizing GPU 155.

The measured or computed value for CPU power 376, NE power 378, DRAM power 380, and/or GPU power 382 can be sampled and be fed as power metrics to TG Power Limiter 370. In some embodiments, one or more of the CPU power 376, NE power 378, DRAM power 380, and/or GPU power 382 values and/or samples can be summed and fed as power metrics to TG Power limiter 370. TG Power Limiter 370 includes a tunable controller having a target power threshold value, T_{POWER}. A difference between T_{POWER} and the power metrics TG Power Limiter 370 is determined and multiplied by a tuning constant, Kᵢ, for the tunable controller of TG Power Limiter 370.

A per-TG power limiter (e.g., TG Power Limiter 370) can generate a CE between 1 and 0. A CE of 0 implies running at a minimum frequency (e.g., utilizing an efficient type core (E-core)) and a CE of 1 implies running at a maximum frequency (e.g., utilizing a performance type core (P-core). When TG power limiter 370 determines that the power metric(s) do not satisfy (e.g., do not exceed) a target power threshold, the CE can be set to a maximum value (e.g., set to 1) indicating that TG power limiter 370 is not engaged. When TG power limiter 370 determines that the power metric(s) satisfy (e.g., exceed) a target power threshold, the CE can be set to an engagedCE value. Tunable controller 372 outputs the power CE for threads of the TG.

Minimum (Min( ) function 374 selects the minimum CE between the performance metric CE output from maximum function 340 and the power CE output from tunable controller 372. When the TG power limiter 370 is not engaged (e.g., the CE from tunable controller 372 is set to 1), the output of Min( ) function 374 will be the CE from maximum function of 340. In other words, the power CE (of 1 being a maximum value) is ignored.

The CE output from Min( ) function 374 is an abstract value on the unit interval that expresses the relative machine performance requirement for a workload. The CE is used as an index into a performance map 345 to determine a recommended cluster type and dynamic voltage and frequency scaling (DVFS) state for the thread group. The recommended DVFS state for E-cores for each of a plurality of thread groups that have been active on a core, is input into a maximum (Max( ) function 367 to determine a recommended maximum DVFS state for E-cores. The recommended DVFS state for P-cores for each of a plurality of thread groups that have been on a core is input into a Max( ) function 366 to determine a recommended maximum DVFS for P-cores. The maximum DVFS state recommended for E-cores (output from Max( ) function 367) and the maximum DVFS state recommended for P-cores (output from Max( ) function 366) is sent to CEL 395, a system-level limiter to determine whether the recommended DVFS states for P-cores and E-cores should be limited. Recommended DVFS states may be limited to reduce heat and/or to conserve power. CEL 395 outputs, to power manager 240, a DVFS state for each cluster of cores, e.g. E-cores DVFS states 371 and P-core DVFS states 392. In an embodiment, DVFS states 371 and 392 can include a bit map that can mask off one or more cores of a cluster, based on control effort limiting by CEL 395.

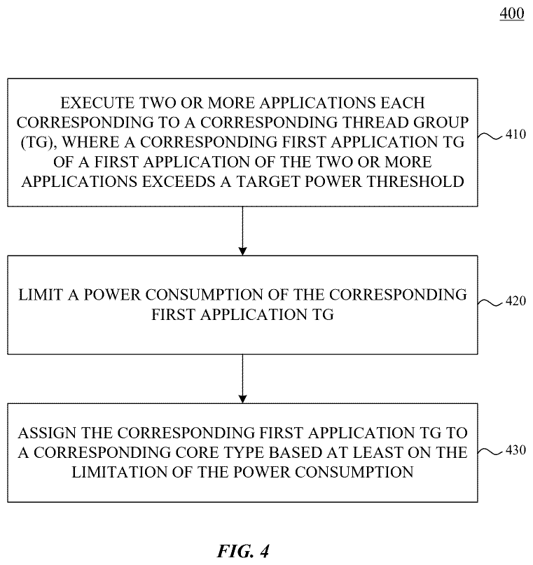

FIG. 4 illustrates example method 400 for a performance controller supporting per-TG power limiters, according to some embodiments of the disclosure. As a convenience and not a limitation, FIG. 4 may be described with reference to elements from other figures in the disclosure. For example, FIG. 4 can describe interactions between subsystems described above, with reference to FIGS. 1-3. Method 400 may be performed by a performance controller that can include for example, one or more processors of computing device 100, a SoC that includes one or more elements of hardware 110 and kernel 121, CLPC 300, and/or system 700 of FIG. 7. For convenience and not a limitation, method 400 will be described as being performed by one or more processors of computing device 100, using the earlier example of a music application and a navigation application running on a computing device (e.g., a mobile phone).

At 410, the one or more processors can execute two or more applications each corresponding to a corresponding TG, where a corresponding first application TG of a first application (e.g., the music application) of the two or more applications exceeds a target power threshold. For example, TG power limiter 370 can determine that one or more per-TG power metrics (e.g., CPU power 376, NE power 378, DRAM Power 380, and/or GPU power 382) exceed (e.g., satisfies) a target power threshold.

At 420, the one or more processors can limit a power consumption of the corresponding first application TG. For example, TG power limiter 370 engages and can set the power CE to an engagedCE value. Thus, even though the TG corresponding to the music application is demanding higher performance, the TG is restricted to requesting increased computational power corresponding to the engaged CE value set by TG power limiter 370.

At 430, the one or more processors can assign the corresponding first application TG to a corresponding core type based at least on the limitation of the power consumption. For example, Min( ) function 374 can select the minimum of the performance CE output from Max( ) function 340 and the power CE output from PI loop 372. The output of Min( ) function 374 is aligned with a corresponding DVFS state of performance map 345.

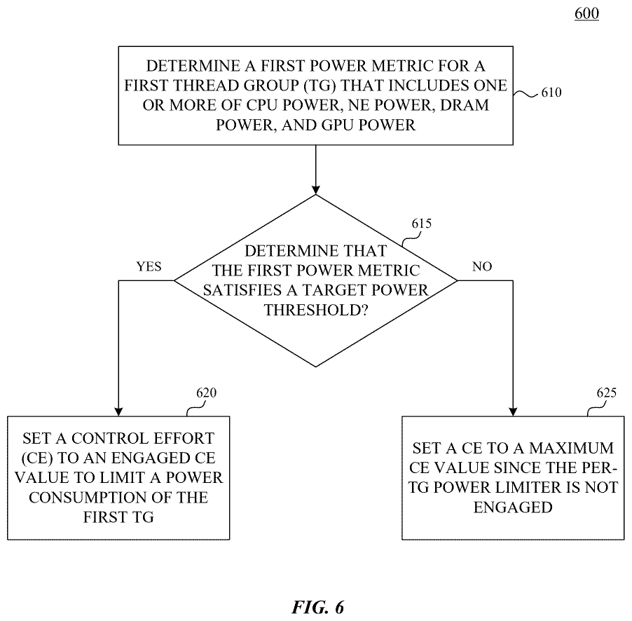

FIG. 6 illustrates example method 600 for a performance controller limiting power consumption, according to some embodiments of the disclosure. As a convenience and not a limitation, FIG. 6 may be described with reference to elements from other figures in the disclosure. For example, FIG. 6 can describe interactions between subsystems described above, with reference to FIGS. 1-4. Method 600 may be performed by a performance controller that can include for example, one or more processors of computing device 100, a SoC that includes one or more elements of hardware 110 and kernel 121, CLPC 300, and/or system 700 of FIG. 7. For convenience and not a limitation, method 600 will be described as being performed by one or more processors of computing device 100, using the earlier example of a music application and a navigation application running on a computing device (e.g., a mobile phone).

Assume it is desirable to limit the music application to 1 watt (W)/E-core fmax which maps to an engaged CE value of 0.3. In this example, E-fmin corresponds to a CE of 0.0 and P-fmax corresponds to a CE of 1.0. The remaining performance states (e.g., DVFS states corresponding to performance map 345) have control efforts in between 0.0 and 1.0. TG power limiter 370 includes logic to calculate power metrics (e.g., CPU, NE, DRAM, and/or GPU) that TG 1 of the music application consumed. TG power limiter 370 can be a closed loop PID controller which takes input as (CPU+NE power) and a target power threshold of 1 watt, and ensures that the power metric(s) input value says below the target power threshold.

At 610, the one or more processors can determine a first power metric for a first TG that includes one or more of CPU power 376, NE power 378, DRAM power 380, and GPU power 382. For example, TG power limiter 370 can calculate a first power metric based on CPU power 376, NE power 378, DRAM power 380, and/or GPU power 382 consumed by TG 1 corresponding to the music application.

At 615, the one or more processors can determine whether the first power metric satisfies a target power threshold. In this example, the target power threshold is 1 W. When the first power metric does not satisfy the target power threshold (e.g., the sum is below 1 W), TG power limiter 370 is not engaged, and method 600 proceeds to 625. When the summed power metrics satisfies the target power threshold (e.g., the sum exceeds 1 W) method 600 proceeds to 620.

At 620, the one or more processors can set a CE to an engaged CE value to limit a power consumption of the first TG of the music application. When the summed power metrics exceeds 1 W, PI loop 372 would return a CE value<1.0 since TG power limiter 370 is engaged and is trying to limit the power consumption of the first TG associated with the music application. As mentioned above, the engaged CE value is 0.3. Consequently, Min( ) 374 would determine a minimum of the output from Max( ) 340 of the performance CE and 0.3 output from PI loop 372.

At 625, the one or more processors can set a CE to a maximum CE value since the per-TG power limiter is not engaged. Since TG power limiter 370 does not have to limit the power consumption of TG 1 corresponding to the music application, PI loop 372 would return a maximum value CE (e.g., 1.0). Consequently, Min( ) 374 would determine a minimum of the output from Max( ) 340 of the performance CE and 1.0 output from PI loop 372. Thus, the power CE of 1.0 will be ignored and the CE of the performance metrics will be used to select a corresponding DVFS state in performance map 345.

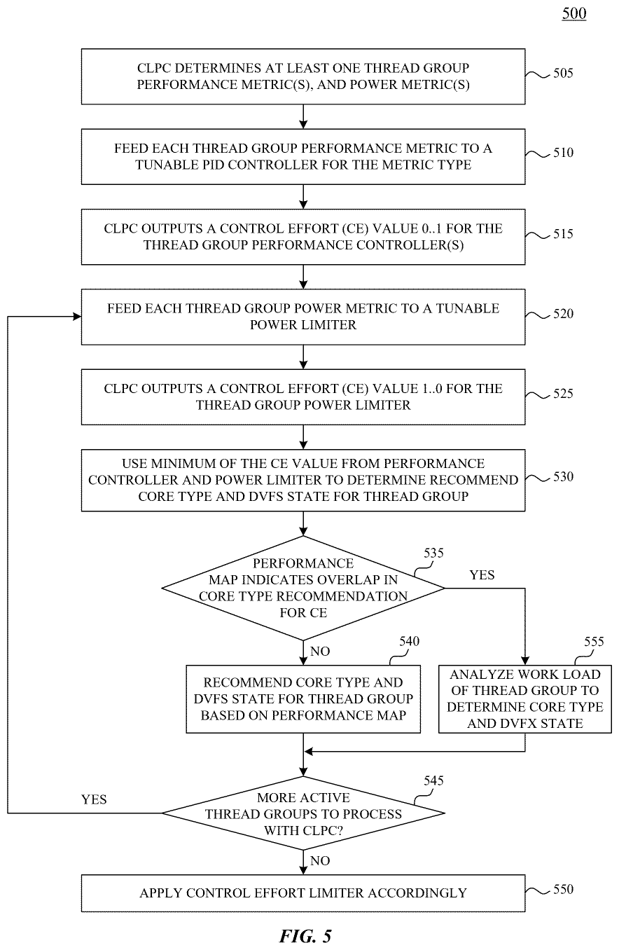

FIG. 5 illustrates example method 500 for a performance controller supporting per-TG power limiters, according to some embodiments of the disclosure. As a convenience and not a limitation, FIG. 5 may be described with reference to elements from other figures in the disclosure. For example, FIG. 5 can describe interactions between subsystems described above, with reference to FIGS. 1-4 and 6. Method 500 may be performed by a performance controller that can include for example, one or more processors of computing device 100, a SoC that includes one or more elements of hardware 110 and kernel 121, CLPC 300, and/or system 700 of FIG. 7. For convenience and not a limitation, method 500 will be described as being performed by a closed loop performance controller (e.g., CLPC 300), using the earlier example of a music application and a navigation application running on a computing device (e.g., a mobile phone).

At 505, CLPC 300 can determine at least one thread group performance metric(s) and power metric(s). For example, CLPC 300 can receive samples of a plurality of performance metrics for thread group 1 corresponding to the music application. A non-limiting example list of performance metrics can include, e.g. a work interval utilization metric 311 for one or more work interval objects (e.g., animation WIO 301, audio WIO 302, block storage I/O 312 rate metric for the thread group, a processor complex utilization metric 314 for the thread group, scheduling latency metric 315 for the thread group, and a cluster residency metric 316 for the thread group.

At 510, CLPC 300 can feed each thread group performance metric to a tunable PID controller for the metric type. Samples of the performance metrics for the thread group can be fed into a plurality of tunable controllers (e.g., PI loops 321, 323-325, and 331). In an embodiment, a tunable controller can be a proportional-integral-derivative (PID) controller or a PI loop controller.

At 515, CLPC 300 can output a CE value in a range of 0 . . . 1 for the thread group performance controllers. For example, Max( ) function 340 can output a performance CE value in a range of 0 . . . 1. For thread group 1 of the music application, CLPC 300 outputs a CE value. In an embodiment, the CE value is a unitless value from 0 to 1.

At 520, CLPC 300 can determine a thread group power metric using a tunable power limiter. For example, CLPC 300 can determine per-TG power metric(s) CPU power 376, NE power 378, DRAM power 380, and/or GPU power 382) to TG power limiter 370. See 410 and 420 of FIG. 4, and FIG. 6.

At 525, CLPC 300 can output a CE value in the range of 0 to 1 for the thread group power limiter. For example, PI loop 372 can output a power CE value.

At 530, CLPC 300 can use a minimum of the CE value from performance controller (e.g., Max( ) function 340) and power limiter (e.g., PI loop 372) to determine a recommended core type and DVFS state for a thread group (e.g., thread group 1 of the music application).

At 535, CLPC 300 can determine whether performance map (e.g., performance map 345) indicates an overlap in core type recommendations for the CE. When there is an overlap, method 500 proceeds to 555. Otherwise, method 500 proceeds to 540.

At 540, CLPC 300 can recommend a core type and DVFS state for the thread group based on a performance map (e.g., performance map 345). In other words, CLPC 300 can assign a corresponding thread group of the first application to a corresponding core type based at least on the limitation of the power consumption output from TG power limiter 370 (e.g., power CE value that may be a maximum CE value or an engaged CE value) as well as the performance CE value output from Max( ) function 340. See 430 of FIG. 4.

At 545, CLPC 300 can determine whether more active thread groups are to be processed. When additional active threads are to be processed, method 500 returns to 520.

Otherwise, method 500 proceeds to 550.

At 550, CLPC 300 can apply control effort limiter, accordingly. (In other words, a system-level limiter e.g., CEL 395 can be applied.)

Returning to 555, CLPC 300 can analyze work load of thread group to determine a core type and DVFX state. After which, method 500 proceeds to 545.

FIG. 7 is an example computer system for implementing some embodiments or portion(s) thereof. Various embodiments can be implemented, for example, using one or more well-known computer systems, such as computer system 700 shown in FIG. 7. Computer system 700 can be any well-known computer capable of performing the functions described herein. For example, and without limitation, computer system 700 may include a SoC, and may perform functions described in: FIGS. 1-3, and can perform methods 400, 500, and 600 of FIGS. 4-6 respectively. For example, the functionality of CLPC 300 and power manager 240 can be performed by system 700. Other apparatuses and/or components shown in the figures may be implemented using computer system 700, or portions thereof.

Computer system 700 includes one or more processors (also called central processing units, or CPUs), such as a processor 704. Processor 704 is connected to a communication infrastructure 706 that can be a bus. One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702. Computer system 700 also includes a main or primary memory 708, such as random access memory (RAM). Main memory 708 may include one or more levels of cache. Main memory 708 has stored therein control logic (e.g., computer software) and/or data. Processor 704 can be communicatively coupled to main memory 708, for example.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to some embodiments, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 700, main memory 708, secondary memory 710 and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 7. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A computing device, comprising:
a memory; and
one or more processors communicatively coupled to the memory, wherein the one or more processors are configured to:
execute two or more applications each corresponding to a corresponding thread group (TG), wherein a corresponding first application TG of a first application of the two or more applications exceeds a target power threshold;
limit a power consumption of the corresponding first application TG; and
assign the corresponding first application TG to a corresponding core type based at least on the limitation of the power consumption.

2. The computing device of claim 1, wherein to limit the power consumption of the corresponding first application TG, the one or more processors are configured to:
determine that a first power metric of the corresponding first application TG exceeds the target power threshold; and
set the first power metric to an engaged control effort (CE) value.

3. The computing device of claim 2, wherein, the one or more processors are configured to:
determine a first CE value corresponding to a first performance metric of the corresponding first application TG;
determine a minimum of the first CE value and the engaged CE value; and
apply the minimum to a corresponding performance map.

4. The computing device of claim 1, wherein, the one or more processors are configured to:
determine that a first power metric of a corresponding second application TG of a second application of the two or more applications does not satisfy the target power threshold; and
set the first power metric to a control effort (CE) value that does not limit power consumption of the corresponding second application TG.

5. The computing device of claim 4, wherein the one or more processors are further configured to:
determine a maximum dynamic voltage and frequency scaling (DVFS) state corresponding to the corresponding first application TG and the corresponding second application TG; and
transmit the maximum DVFS state to a system-level control effort limiter.

6. The computing device of claim 1, wherein the one or more processors are further configured to:
determine the power consumption of the corresponding first application TG including: calculate a central processing unit (CPU) power and a neural engine (NE) power consumed by the corresponding first application TG.

7. The computing device of claim 1, wherein the one or more processors are further configured to:
determine the power consumption of the corresponding first application TG including: calculate a dynamic random-access memory (DRAM) power and a graphics processing unit (GPU) power consumed by the corresponding first application TG.

8. A non-transitory computer-readable medium storing instructions that, upon execution by one or more processors of a computing device, cause the computing device to perform operations, the operations comprising:
executing two or more applications each corresponding to a corresponding thread group (TG), wherein a corresponding first application TG of a first application of the two or more applications exceeds a target power threshold;
limiting a power consumption of the corresponding first application TG; and
assigning the corresponding first application TG to a corresponding core type based at least on the limitation of the power consumption.

9. The non-transitory computer-readable medium of claim 8, wherein to limit the power consumption of the corresponding first application TG, the operations comprise:
determining that a first power metric corresponding to the corresponding first application TG exceeds the target power threshold; and
setting the first power metric to an engaged control effort (CE) value.

10. The non-transitory computer-readable medium of claim 9, wherein, the operations further comprise:
determining a first CE value corresponding to a first performance metric of the corresponding first application TG;
determining a minimum of the first CE value and the engaged CE value; and
applying the minimum to a corresponding performance map.

11. The non-transitory computer-readable medium of claim 8, wherein, the operations further comprise:
determining that a first power metric of a corresponding second application TG of a second application of the two or more applications does not satisfy the target power threshold; and
setting the first power metric to a control effort (CE) value that does not limit power consumption of the corresponding second application TG.

12. The non-transitory computer-readable medium of claim 11, wherein the operations further comprise:
determining a maximum dynamic voltage and frequency scaling (DVFS) state corresponding to the corresponding first application TG and the corresponding second application TG; and
transmitting the maximum DVFS state to a system-level control effort limiter.

13. The non-transitory computer-readable medium of claim 8, wherein the operations further comprise:
determining the power consumption of the corresponding first application TG including: calculating a central processing unit (CPU) power and a neural engine (NE) power consumed by the corresponding first application TG.

14. The non-transitory computer-readable medium of claim 8, wherein the operations further comprise:
determining the power consumption of the corresponding first application TG including: calculating a dynamic random-access memory (DRAM) power and a graphics processing unit (GPU) power consumed by the corresponding first application TG.

15. A method for a performance controller, comprising:
executing two or more applications each corresponding to a corresponding thread group (TG), wherein a corresponding first application TG of a first application of the two or more applications exceeds a target power threshold, wherein the first application corresponds to a first TG;
limiting a power consumption of the corresponding first application TG; and
assigning the corresponding first application TG to a corresponding core type based at least on the limitation of the power consumption.

16. The method of claim 15, wherein to limit the power consumption of the corresponding first application TG, the method comprises:
determining that a first power metric corresponding to the corresponding first application TG exceeds the target power threshold; and
setting the first power metric to an engaged control effort (CE) value.

17. The method of claim 16, further comprising:
determining a first CE value corresponding to a first performance metric of the corresponding first application TG;
determining a minimum of the first CE value and the engaged CE value; and
applying the minimum to a corresponding performance map.

18. The method of claim 15, further comprising:
determining that a first power metric of a corresponding second application TG of a second application of the two or more applications does not satisfy the target power threshold; and
setting the first power metric to a control effort (CE) value that does not limit power consumption of the corresponding second application TG.

19. The method of claim 18, further comprising:
determining a maximum dynamic voltage and frequency scaling (DVFS) state corresponding to the corresponding first application TG and the corresponding second application TG; and
transmitting the maximum DVFS state to a system-level control effort limiter.

20. The method of claim 15, further comprising:
determining the power consumption of the corresponding first application TG including: calculating a dynamic random-access memory (DRAM) power and a graphics processing unit (GPU) power consumed by the corresponding first application TG.
